(19) United States
(12) Patent Application Publication
(10) Pub. No.: US 2005/0271238 A1
(43) Pub. Date: Dec. 8, 2005

(54) Resin frame, speaker unit and speaker device

(76) Inventors: Hiroyuki Kobayashi, Yamagata (JP); Kenichi Kasahara, Yamagata (JP); Shinichi Hayasaka, Yamagata (JP); Toshihiro Hikichi, Yamagata (JP)

Correspondence Address: YOUNG & THOMPSON, 745 SOUTH 23RD STREET, 2ND FLOOR, ARLINGTON, VA, 22202, US

(21) Appl. No.: 11/085,140

(22) Filed: Mar. 22, 2005

(30) Foreign Application Priority Data
Mar. 25, 2004 (JP) 2004-89283

(51) Int. Cl. H04R 25/00

(52) U.S. Cl. 381/398; 381/433

(57) ABSTRACT

A speaker device is coaxial type two-way speaker, and includes speaker units for low-frequency band reproduction and for high-frequency band reproduction respectively. The speaker unit for low-frequency band reproduction includes a vibration system such as a resin frame and a magnetic circuit system such as a yoke. The resin frame has a mounting portion onto which the magnetic circuit system is mounted, and an annular projecting portion supporting a bottom surface of the yoke is formed on the upper surface of the mounting portion. Since the bottom surface of the yoke is supported only by the projecting portion, not by the entire bottom surface of the resin frame, even when flatness of the bottom surface of the resin frame is insufficient or different, the yoke can be horizontally mounted.

### TECHNICAL FIELD

The present invention relates to a configuration of a resin frame in a speaker device.

### BACKGROUND ART

Conventionally, there is known an external magnet type speaker device including a pole piece having a flange-shape yoke, an annular magnet and an annular plate. In such the speaker device, the annular magnet is disposed on the yoke included in the pole piece and the plate is further disposed on the magnet. Thereby, an external magnet type magnetic circuit is configured. In such the external magnet type speaker device, in a state that the bottom surface of the yoke is opposed to an inner surface (hereinafter referred to as “mounting portion”) of the resin frame, by applying an adhesive agent onto those opposite surfaces, the magnetic circuit is fixed onto the resin frame.

As the speaker device having this kind of magnetic circuit, there is known a speaker in which a magnetic circuit is fixed in a resin case by screwing a root portion of the resin frame to an opening portion of the resin case (see Japanese Patent Application Laid-Open No. 10-23596, for example). There is also known a speaker in which a joining means is provided between a frame and a resin cover, and in which a magnetic circuit having a magnet, a plate and a pole piece is fixed between the frame and the resin cover (see Japanese Patent Application Laid-Open No. 2001-359189).

However, in the above speaker device, since the magnetic circuit is fixed onto the mounting portion of the resin frame having rigidity lower than a metallic frame by the adhesive agent, when a flatness of the mounting portion is insufficient due to forming accuracy of the resin frame, the magnetic circuit is fixed onto the resin frame in an inclined state. In addition, when the mounting portion is bent and deformed, the yoke and the resin frame partly peel off, which sometimes causes insufficient adhesion. Therefore, it is problematic that the magnetic circuit cannot be stably fixed onto the mounting portion at the time of adhesion of the bottom surface of the yoke to the mounting portion of the resin frame.

### DISCLOSURE OF THE INVENTION

As an object to be achieved by the present invention, the above described object is cited as an example. The present invention has its object to provide a speaker device capable of stably fixing a magnetic circuit onto a mounting portion of a resin frame.

According to one aspect of the present invention, there is provided a resin frame for a speaker unit, including a mounting portion onto which a magnetic circuit including a yoke is mounted, wherein a projecting portion supporting a bottom surface of the yoke is formed on a surface of the mounting portion, opposite to the bottom surface of the yoke.

The above-mentioned resin frame has the mounting portion on which the magnetic circuit is mounted. For example, in a case of the resin frame in a pot or pan shape, the inner bottom surface becomes the mounting portion. On the mounting portion, the projecting portion for supporting the bottom surface of the yoke is provided. Thus, the magnetic circuit is mounted on the resin frame in the state that the bottom surface of the yoke is supported from the lower side by the projecting portion. Namely, the magnetic circuit is supported only by the projecting portion formed on the mounting portion, not by the entire surface of the mounting portion. Though the mounting portion of the resin frame is basically formed into a flat surface, actually, the flatness of the mounting portion is insufficient or different due to the forming accuracy of the resin. However, by the above resin frame, since the magnetic circuit is supported by the projecting portion formed on the mounting portion, even though the flatness of the mounting portion itself is insufficient, the magnetic circuit can be horizontally mounted onto the mounting portion without receiving an effect thereof, and can be stably mounted to the resin frame.

According to another aspect of the present invention, there is provided a speaker unit, including: a magnetic circuit including a yoke; and a resin frame including a mounting portion onto which the magnetic circuit is mounted, wherein a projecting portion supporting a bottom surface of the yoke is formed on a surface of the mounting portion, opposite to the bottom surface of the yoke.

In the above speaker unit, the resin frame has the mounting portion onto which the magnetic circuit is mounted. On the mounting portion, the projecting portion supporting the bottom surface of the yoke is provided. Therefore, the magnetic circuit is mounted on the resin frame in the state that the bottom surface of the yoke is supported from the lower side by the projecting portion. Namely, the magnetic circuit is supported only by the projecting portion formed on the mounting portion, not by the entire surface of the mounting portion. Therefore, even when the flatness of the mounting portion is insufficient or different due to the forming accuracy of the resin, since the magnetic circuit is supported by the projecting portion formed on the mounting portion, the magnetic circuit can be horizontally mounted on the mounting portion without receiving the effect. As a result, the magnetic circuit can be stably mounted onto the resin frame.

In a form of the above speaker unit, the projecting portion may be formed into an annular shape, or the plural projecting portions may be formed in a circumferential direction of the mounting portion with predetermined spaces with each other.

In a form of the above speaker unit, the magnetic circuit and the resin frame may have openings at center portions thereof, and the magnetic circuit may be fixed to the resin frame by a fastening member inserted into the openings. In this form, the magnetic circuit, which is horizontally supported by the projecting portion formed on the mounting portion, is fixed to the resin frame by the fastening member. At this time, when the fastening member is fastened with the projecting portion serving as a fulcrum, since the frame from the projecting portion to the opening portion functions as a screw and hardly loosens with respect to the diaphragm, the magnetic circuit can be strongly fastened. As the fastening member, a screw and a bolt can be used, for example.

According to another aspect of the present invention, there is provided a speaker device including the above speaker unit and another speaker unit disposed coaxially with respect to the speaker unit by the fastening member. In this form, the above-mentioned speaker unit is applicable to a so-called coaxial speaker.

### BRIEF DESCRIPTION OF THE DRAWINGS

FIG. 1A shows a sectional view of a speaker device according to an embodiment of the present invention, and FIG. 1B shows a rear view thereof;

FIG. 2 shows a sectional view in which an area in a vicinity of a yoke and a mounting portion of a resin frame is enlarged;

FIGS. 3A and 3B are sectional views in which the area in the vicinity of the yoke and the mounting portion is enlarged when fastening of a fastening member to a fastening hole is strong; and

FIG. 4 shows a rear view of another state of a projecting portion formed on the mounting portion of the resin frame.

### BEST MODE FOR CARRYING OUT THE INVENTION

A preferred embodiment of the present invention will be explained herein after with reference to the drawings. In this embodiment, at the time of adhering the bottom surface of the yoke and the mounting portion of the resin frame, a magnetic circuit of a speaker unit for low-frequency band reproduction is stably fixed onto the mounting portion.

[Configuration of Speaker Device]

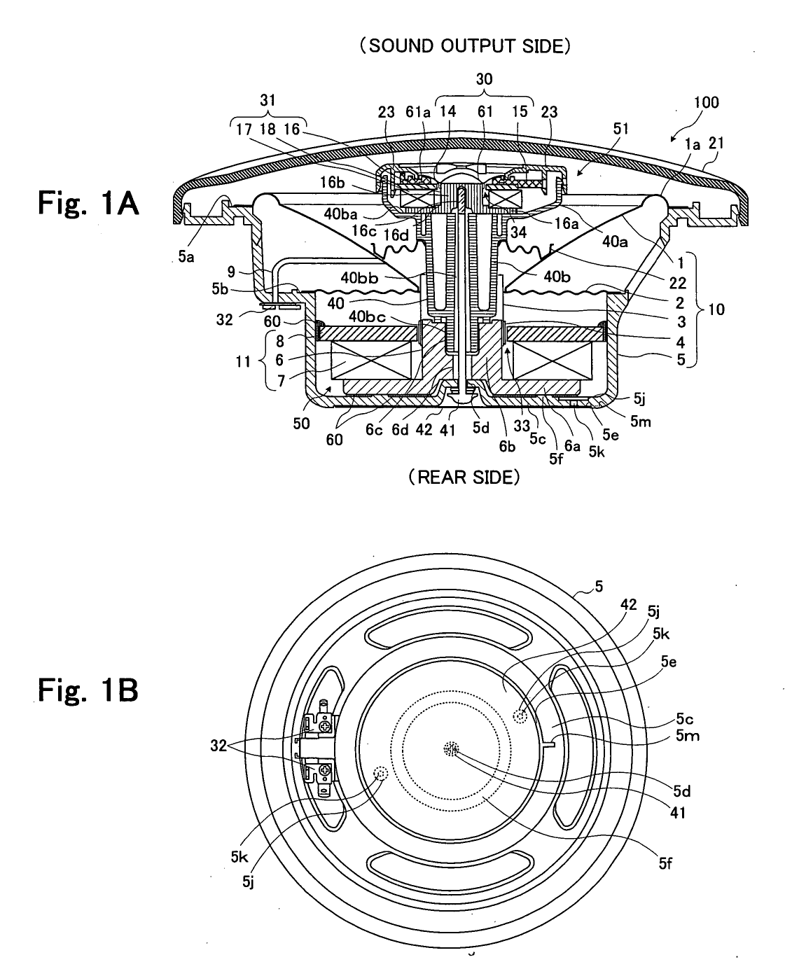

First, in FIGS. 1A and 1B, an outline configuration of a speaker device 100 according to the embodiment of the present invention is schematically shown. FIG. 1A is a sectional view when the speaker device 100 is cut along a plane containing a central axis thereof. FIG. 1B is a rear view of the speaker device 100. The speaker device 100 in the embodiment can be used preferably as a marine speaker or a vehicle speaker. As below, referring to FIGS. 1A and 1B, the configuration etc. of the speaker device 100 of the embodiment will be described.

The speaker device 100 includes a speaker unit 50 for low-frequency band reproduction, a speaker unit 51 for high-frequency band reproduction, and other various kinds of members. The speaker device 100 is a so-called coaxial type two-way speaker, and is configured by coaxially disposing the speaker unit 51 for high-frequency band reproduction at the sound output side and the speaker unit 50 for low-frequency band reproduction at the rear side. Accordingly, the speaker device 100 can realize flat sound reproduction from the low-frequency band to the high-frequency band. Incidentally, the speaker unit 50 for low-frequency band reproduction may be a speaker unit capable of low and middle frequency band reproduction. Further, the speaker unit 51 for high-frequency band reproduction may be a speaker unit capable of high and middle frequency band reproduction.

First, a configuration of the speaker unit 50 for low-frequency band reproduction will be described. The speaker unit 50 for low-frequency band reproduction mainly includes a vibration system 10 having a diaphragm 1, a damper 2, a waterproof damper 22, a voice coil bobbin 3, a voice coil 4 and a resin frame 5, a magnetic circuit system 11 having a pole piece 6, an annular magnet 7 and an annular plate 8, and a resin grille 21.

First, the respective constitutive elements of the vibration system 10 will be described.

The diaphragm 1 is a so-called conical diaphragm, and a separate edge portion 1a is bonded thereto or the diaphragm 1 is formed integrally with the edge portion 1a. Various kinds of materials such as paper, polymer or metal can be applied to the diaphragm 1 according to various kinds of application. The outer peripheral edge of the diaphragm 1, namely, the lower end part of the edge portion 1a is fixed onto a first flange portion 5a located at the upper part of the resin frame 5. On the other hand, the inner peripheral edge of the diaphragm 1 is fixed onto the vicinity of the upper end of the outer circumferential wall of the voice coil bobbin 3.

The damper 2 is made of a material of cloth impregnated with a thermosetting resin such as phenol resin or the like, and plural corrugations are concentrically formed. The damper 2 movably supports the voice coil bobbin 3. The inner peripheral edge of the damper 2 is fixed to the outer circumferential wall of the voice coil bobbin 3. On the other hand, the outer peripheral edge of the damper 2 is fixed onto a second flange portion 5b formed in the vicinity of the central part of the resin frame 5.

The waterproof damper 22 fulfills a function of preventing water droplets etc. from entering from the sound output side into the magnetic circuit system 11 etc. For the purpose, as a material for the waterproof damper 22, for example, a material such as thermoplastic elastomer is appropriate. The outer peripheral edge of the waterproof damper 22 is mounted in a predetermined position of the diaphragm 1, and the inner peripheral edge of the waterproof damper 22 is mounted to the outer circumferential wall of a connecting portion 40b of a supporting member 40, which will be described later.

The voice coil bobbin 3 has a substantially cylindrical shape. The voice coil 4 is wound around the outer circumferential wall of the lower end part of the voice coil bobbin 3. Further, the outer circumferential wall of the lower end part of the voice coil bobbin 3 faces the inner circumferential wall of the annular plate 8 with a certain space therebetween. Furthermore, the inner circumferential wall of the lower end part of the voice coil bobbin 3 faces the outer circumferential wall of the upper end part of the pole piece 6 with a certain space therebetween. Thus, a gap (magnetic gap 33) is formed between the outer circumferential wall of the upper end part of the pole piece 6 and the inner circumferential wall of the plate 8.

The voice coil 4 has positive/negative lead terminals (not shown). The positive side lead terminal is an input terminal of L (or R) channel signal, and the negative side lead terminal is an input terminal of ground (GND: earth) signal. The respective lead terminals are electrically connected to the ends of respective tinsel wires 9 in the predetermined position of the diaphragm 1 and the other ends of the respective tinsel wires 9 are electrically connected to a connection terminal 32. To the voice coil 4, electric signals for one channel are input from an amplifier (not shown) side via the connection terminal 32 and the tinsel wires 9.

The resin frame 5 is a frame made of a resin material. Onto the resin frame 5, various components of the speaker device 100 are fixed, and the resin frame 5 serves to support the speaker device 100. The resin frame 5 has a shape of a pan or pot opening upwardly, and has the first flange portion 5a that supports the edge portion 1a of the diaphragm 1, the second flange portion 5b that supports the outer peripheral edge of the damper 2, and a mounting portion 5c on which the magnetic circuit system 11 is placed.

The first flange portion 5a is formed in a position of the upper part of the resin frame 5, and the second flange portion 5b is formed in a position of the central part of the resin frame 5. The mounting portion 5c is formed in a position at the lower part side of the resin frame 5, namely, at the rear side thereof. A recess having a truncated cone shape is formed in the vicinity of the central axis of the mounting portion 5c from the lower surface side to the upper surface side thereof. The mounting portion 5c has an opening 5d on the central axis thereof, a step portion 5j and a hole portion 5k in the vicinity of the peripheral edge thereof, and a recess (concave) portion 5e and a slit 5m at the rear side thereof. The step portion 5j, the hole portion 5k, the recess portion 5e and the slit 5m serve to prevent production of air bubbles of an adhesive agent 60 due to volume change of space between the magnetic circuit system 11 and the resin frame 5 at the time of assembly of the speaker unit 50 for low-frequency band reproduction. A fastening member 41, which will be described later, penetrates the opening 5d, and a nameplate 42, which will be described later, is attached to the recess portion 5e. The name plate 42 is used for application of improvement of the appearance of the rear side of the speaker 100 or recognition of product information etc. for users.

Next, the respective constitutive elements of the magnetic circuit system 11 will be described.

The magnetic circuit system 11 is formed as an external magnet type magnetic circuit. This magnetic circuit has the pole piece 6, the annular magnet 7 and the annular plate 8.

The pole piece 6 has an inverted T section. The pole piece 6 is fixed onto the mounting portion 5c of the resin frame 5 via the adhesive agent 60. The pole piece 6 has a flange-like yoke 6a, a center pole 6b having a cylindrical shape, and openings 6c and 6d provided within the center pole 6b.

The yoke 6a is located on the mounting portion 5c of the resin frame 5. A recess having a truncated cone shape is formed in the vicinity of the central axis of the lower surface side of the center pole 6b. The openings 6c and 6d formed within the center pole 6b are respectively different in diameter, and the openings communicate with each other. The opening 6c has a diameter slightly larger than that of the opening 6d, and is formed from the vicinity of the central part of the center pole 6b to the upper part thereof. On the other hand, the opening 6d is formed at the lower end side of the opening 6c, namely, from the central part side of the center pole 6b to the lower part thereof. Further, a lower end portion 40bc of the supporting member 40, which will be described later, is inserted into the opening 6c and the supporting member 40 is fastened to the center pole 6b. Furthermore, the fastening member 41 penetrates the openings 6c and 6d. Note that the fastening member 41 penetrates the opening 6c via a thorough hole 40bb of the supporting member 40, which will be described later.

The annular magnet 7 is disposed so as to be overlapped with the upper surface of the yoke 6a, and the annular plate 8 is disposed so as to be overlapped with the upper surface of the annular magnet 7. The center pole 6b upwardly extends within the openings of the central parts of the annular magnet 7 and the annular plate 8. The outer peripheral edge of the plate 8 is fixed for reinforcement to the inner circumferential wall of the resin frame 5 via the adhesive agent 60.

In the magnetic circuit system 11, a magnetic circuit is formed by the magnet 7, the plate 8 and the pole piece 6, and the magnetic flux of the magnet 7 is concentrated in the magnetic gap 33 formed between the inner circumferential wall of the plate 8 and the outer circumferential wall of the pole piece 6.

The resin grille 21 is made of a resin material, for example, and has a function of protecting the speaker unit 50 for low-frequency band reproduction and the speaker unit 51 for high-frequency band reproduction, or the like. For this purpose, the resin grille 21 is mounted on the resin frame 5 so as to cover the speaker units. Further, striped spacings (not shown) are formed intermittently at the upper surface side of the resin grille 21 so that the speaker unit 50 for low-frequency band reproduction and the speaker unit 51 for high-frequency band reproduction can emit sound waves through the spacings to the sound output side.

Next, the speaker unit 51 for high-frequency band reproduction will be described. The speaker unit 51 for high-frequency band reproduction mainly includes a vibration system 30 having a diaphragm 61, a voice coil 14 and an upper frame 15, and a magnetic circuit system 31 having a pole piece 16, an annular magnet 17 and an annular plate 18, and a cover 23.

First, the respective constitutive elements of the vibration system 30 will be described.

The diaphragm 61 is a so-called domical diaphragm, and is formed integrally with an edge portion 61a. Various kinds of materials such as paper, polymer, or metal can be applied to the diaphragm 61 according to various kinds of application as well as the above diaphragm 1. The outer peripheral edge of the diaphragm 61, namely, the lower end part of outer peripheral edge of the edge portion 61a is fixed onto the upper surface of the resin frame 15.

The voice coil 14 has a substantially cylindrical shape. The outer circumferential wall of the voice coil 14 faces the inner circumferential wall of the annular plate 18 with a certain space therebetween. On the other hand, the inner circumferential wall of the voice coil 14 faces the outer circumferential wall of the upper end part of the pole piece 16 with a certain space therebetween. Thus, a gap (magnetic gap 34) is formed between the outer circumferential wall of the pole piece 16 and the inner circumferential wall of the plate 18.

Further, the voice coil 14 has positive/negative lead terminals (not shown). The positive side lead terminal is an input terminal of L (or R) channel signal, and the negative side lead terminal is an input terminal of ground (GND: earth) signal. The respective lead terminals are electrically connected to the ends of respective tinsel wires (not shown) and the other ends of the respective tinsel wires (not shown) are electrically connected to a connection terminal (not shown) To the voice coil 14, electric signals for one channel are input from an amplifier (not shown) side via the connection terminal and the tinsel wires.

The upper frame 15 is made of a resin material and has a substantially annular form. The upper frame 15 is disposed so as to be overlapped with the upper surface of the annular plate 18. The upper frame 15 supports the outer peripheral edge of the diaphragm 61, namely, the edge 61a.

Next, the respective constitutive elements of the magnetic circuit system 31 will be described.

The magnetic circuit system 31 is formed as an external magnet type magnetic circuit system. The magnetic circuit has the pole piece 16, the annular magnet 17 and the annular plate 18.

The pole piece 16 has an inverted T section. Flatness is ensured in the lower surface of the pole piece 16. The pole piece 16 is fixed onto an upper end surface 40ba of the supporting member 40 via the adhesive agent 60 (not shown). The pole piece 16 has a flange-like yoke 16a, a center pole 16b having a cylindrical shape, a fastening hole 16c provided within the center pole 16b, and a step portion 16d formed between the outer peripheral edge of the lower end part of the center pole 16b and the yoke 16a and having a step-like section.

The yoke 16a is located on the upper end surface 40ba of the supporting member 40. A recess having a truncated cone shape is formed in the vicinity of the central axis of the lower surface side of the center pole 16b. The fastening hole 16c has a female thread, for example, and the leading end (for example, male thread) of the fastening member 41 is inserted and screwed. The outer circumferential wall of the step portion 16d is in contact with the outer circumferential wall of the lower end part of the magnet 17.

The annular magnet 17 is disposed so as to be overlapped with the upper surface of the yoke 16a. The inner circumferential wall of the lower end part of the annular magnet 17 is disposed at the outer circumferential side of the step portion 16d of the pole piece 16 as described above, and the annular magnet 17 is precisely positioned in a predetermined position on the yoke 16a. The annular plate 18 is disposed so as to be overlapped with the upper surface of the annular magnet 17.

In the magnetic circuit system 31, a magnetic circuit is formed by the magnet 17, the plate 18 and the pole piece 16, and the magnetic flux of the magnet 17 is concentrated in the magnetic gap 34 formed between the inner circumferential wall of the plate 18 and the outer circumferential wall of the pole piece 16.

The cover 23 is made of a resin material, for example, and mounted on a frame portion 40a of the supporting member 40, which will be described later, for covering the sound output side of the speaker unit 51 for high-frequency band reproduction. The cover 23 has a function of protecting the speaker unit 51 for high-frequency band reproduction, or the like.

As other various members of the speaker device 100, the supporting member 40, the fastening member 41 and the nameplate 42 are included.

The supporting member 40 has the connecting portion 40b having a cylindrical shape and the frame portion 40a extending from the upper end surface 40ba of the connecting portion 40b upwardly so as to cover the periphery of the speaker unit 51 for high-frequency band reproduction. The cover 23 is mounted on the frame portion 40a and covers the speaker unit 51 for high-frequency band reproduction. The connecting portion 40b coaxially arranges the speaker unit 50 for low-frequency band reproduction and the speaker unit 51 for high-frequency band reproduction. The lower end part 40bc of the connecting portion 40b is inserted into the opening 6c of the pole piece 6 and fastened as described above. The speaker unit 51 for high-frequency band reproduction is fixed to the upper end surface 40ba having flatness via the adhesive agent 60 (not shown). The through hole 40bb is formed within the connecting portion 40b so that it penetrates on the central axis thereof in a vertical direction, and the fastening member 41 penetrates the through hole 40bb.

As the fastening member 41, for example, a member such as a male screw or bolt is appropriate. At the leading end of the fastening member 41, a male thread corresponding to the female thread of the fastening hole 16c is formed. The fastening member 41 is inserted into the fastening hole 16c from the rear side of the speaker device 100 through the openings 5d, 6d and 6c and the through hole 40bb. Thereby, the speaker unit 50 for low-frequency band reproduction and the speaker unit 51 for high-frequency band reproduction are coaxially fixed via the supporting member 40.

The nameplate 42 is made of a polymer material or metal material and has a disc shape. The nameplate 42 is attached to the recess portion 5e of the resin frame 5 with a sticking agent or adhesive agent as described above. The product information, company name, etc. are printed on the nameplate 42.

In the above described speaker device 100, when electric signals are input to the respective tinsel wires from the amplifier side, the electric signals are supplied to the voice coils 4 and 14 via the respective lead terminals of the voice coils 4 and 14. Thereby, driving forces are generated in the voice coils 4 and 14 within the magnetic gaps 33 and 34, respectively, and the diaphragms 1 and 61 are vibrated in the axis direction of the speaker device 100. Thus, the speaker device 100 emits sound waves to the sound output side.

[Configuration of Resin Frame]

Next, the description will be given of the configuration of the resin frame 5 for stably fastening the magnetic circuit system 11 of the speaker unit 50 for low-frequency band reproduction onto the mounting portion 5c of the resin frame 5, with reference to FIGS. 1A and 1B to FIGS. 3A and 3B.

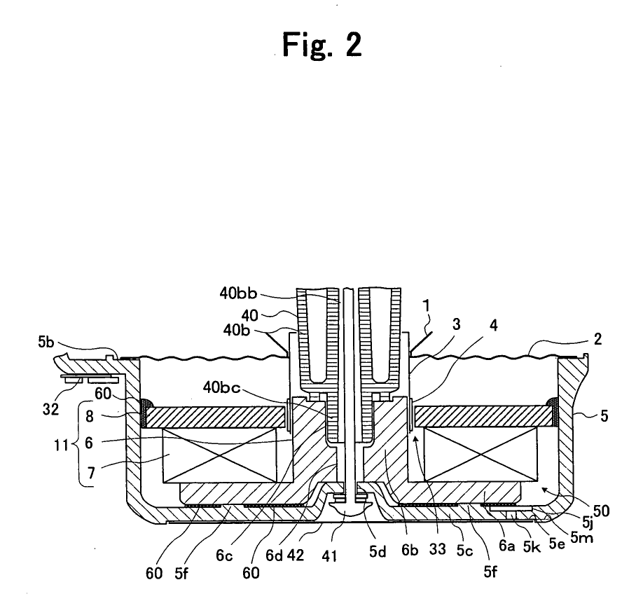

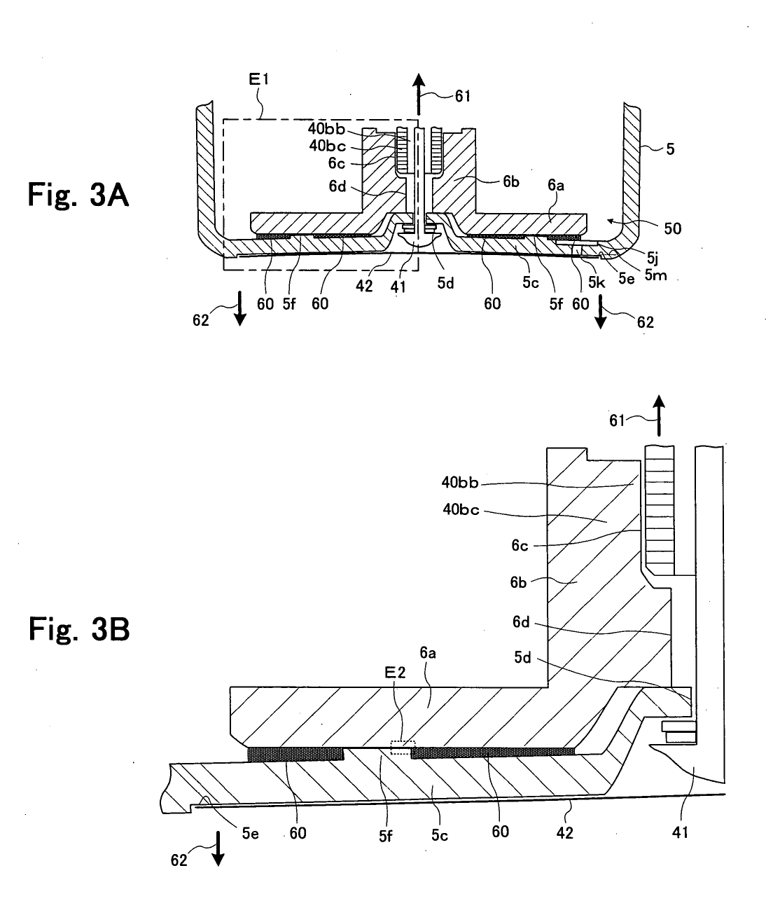

FIG. 2 shows a sectional view in which the yoke 6a and the mounting portion 5c shown in FIG. 1A are enlarged. FIG. 3A shows a sectional view in which the area around the yoke 6a and the mounting portion 5c is enlarged in a case that the fastening of the fastening member 41 with respect to the fastening hole 16c is too strong. FIG. 3B shows a sectional view in which an area E1 (an area surrounded by a chain line) in FIG. 3A is enlarged.

In the speaker device 100, as shown in FIG. 1B and FIG. 2, the annular projecting portion 5f is formed on the mounting portion 5c corresponding to the vicinity of the outer peripheral edge of the yoke 6a. The yoke 6a is supported by the annular projecting portion 5f.

Since the resin frame 5 is produced by forming the resin, the flatness degrees of the bottom surfaces of the mounting portions 5c are sometimes different. When the projecting portion 5f is not formed on the mounting portion 5c, the yoke 6a is supported by the entire bottom surface of the mounting portion 5c. Therefore, if the flatness degrees of the bottom surfaces of the mounting portions 5c are different, due to the effect, it becomes difficult that the yoke 6a is horizontally mounted onto the mounting portion 5c. Meanwhile, in the present invention, the yoke 6a is received (supported) only by the projecting portion 5f in the annular shape, not by the entire bottom surface of the mounting portion 5c. Thus, even when the flatness degrees of the bottom surfaces of the mounting portions 5c are sometimes different, the yoke 6a can be horizontally mounted without receiving the effect.

It is noted that the projecting portion 5f is simultaneously formed at the time of forming the resin frame 5. Thus, by forming the projecting portion 5f, the cost of the resign frame 5 is never raised to a large extent. In this embodiment, the only one annular projecting portion 5f is formed on the mounting portion 5c. However, the plural projecting portions 5f may be formed in the circumferential direction.

The bottom surface of the yoke 6a, in contact with the upper surface of the projecting portion 5f, is fastened onto the mounting portion 5c via the adhesive agent 60. Since the projecting portion 5f is formed, a gap is formed between the bottom surface of the yoke 6a and the upper surface of the mounting portion 5c (other than the projecting portion 5f), and the adhesive agent 60 is inserted into the gap at the time of the adhesion. In comparison with the speaker device in which the bottom surface of the yoke and the mounting portion having no projecting portion are fixed via the adhesive agent, the speaker device 100 in this embodiment needs more adhesion agent, and the adhesion strength of the magnetic circuit system 11 of the speaker unit 50 for low-frequency band reproduction and the mounting portion 5c of the resin frame 5 is enhanced. Thereby, the magnetic circuit system 11 can be stably fastened onto the mounting portion 5c.

In addition, in the present speaker device 100, even when the fastening of the fastening member 41 to the fastening hole 16c is strong, the magnetic circuit system 11 can be stably fastened onto the mounting portion 5c. Namely, as shown in FIG. 3A, when the fastening of the fastening member 41 with respect to the fastening hole 16c is strong, the fastening member 41 moves in the direction of an arrow 61. Therefore, the vicinity of the center axis of the mounting portion 5c of the resin frame 5 having lower rigidity than a metallic frame is bent in the direction of the arrow 61, and the outer peripheral edge portion of the mounting portion 5c is bent in the direction of an arrow 62. Thus, in the case of the speaker device in which the bottom surface of the yoke is only attached onto the surface of the mounting portion having no projecting portion via the adhesive agent, the outer peripheral edge portion of the bottom surface of the yoke and the outer peripheral edge portion on the correspondent mounting portion surface become apart from each other, and the adhesion strength therebetween decreases. In some cases, improper adhesion may occur.

On the contrary, in the speaker device 100, as shown in the enlarged sectional view of FIG. 3B, even if such the deformation occurs to the mounting portion 5c, since an area E2 (an area surrounded by the broken line) of a part of the projecting portion 5f is deformed and supports the bottom surface of the yoke 6a, it can be prevented that the outer peripheral edge portion of the bottom surface of the yoke becomes apart from the mounting portion 5c. The magnetic circuit system 11 is never mounted onto the mounting portion 5c in an unstable state (e.g., in an inclined state). Therefore, the magnetic circuit system 11 of the speaker unit 50 for low-frequency band reproduction can be fastened onto the mounting portion 5c in the stable state.

Additionally, in the speaker device 100, the fastening member 41 is inserted into and passes through the opening 5d of the resin frame 5, the openings 6c and 6d of the pole piece 6 and the through hole 40bb of the supporting member 40 in this order from the rear side to the sound output side, and the fastening member 41 and the fastening hole 16c are joined by the screw. Thus, the magnetic circuit system 11 of the speaker unit 50 for low-frequency band reproduction and the magnetic circuit system 31 of the speaker unit 51 for high-frequency band reproduction can be coaxially fixed to each other via the supporting member 40.

[Modification]

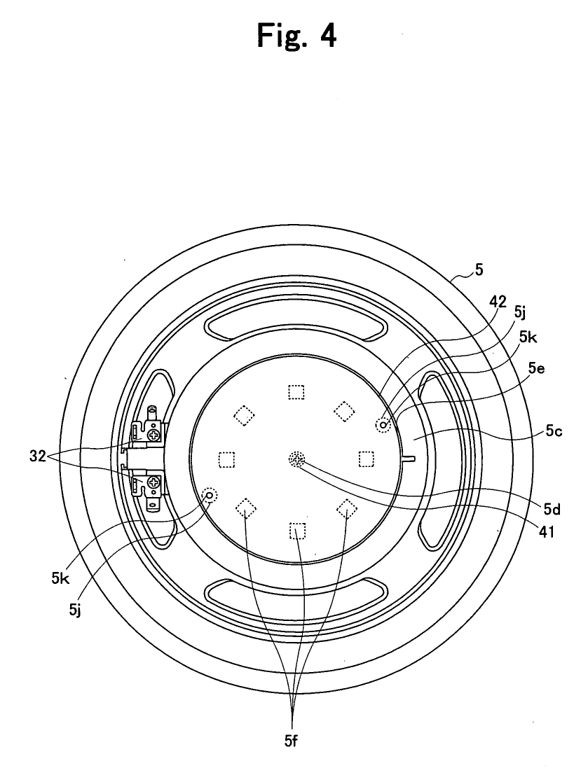

In the above embodiment, the annular projecting portion 5f is formed on the upper surface of the mounting portion 5c, but the application of the present invention is not limited to this. As shown in the rear view of the resin frame 5 shown in FIG. 4, the plural independent projecting portions 5f may be formed on the upper surface of the mounting portion 5c in the circumferential direction. In the resin frame 5 having such the plural projecting portions 5f, even when the flatness degrees of the bottom surfaces of the mounting portions 5c are different, the bottom surface of the yoke 6a is supported by the plural projecting portions 5f. Therefore, the bottom surface of the yoke 6a is not affected by the differences of the flatness degrees of the bottom surfaces of the resin frames. Thus, the magnetic circuit system 11 of the speaker unit 50 for low-frequency band reproduction can be fastened onto the mounting portion 5c in the stable state.

1. A resin frame for a speaker unit, comprising a mounting portion onto which a magnetic circuit including a yoke is mounted,
wherein a projecting portion supporting a bottom surface of the yoke is formed on a surface of the mounting portion opposite to the bottom surface of the yoke.

2. A speaker unit, comprising:
a magnetic circuit including a yoke; and
a resin frame including a mounting portion onto which the magnetic circuit is mounted,
wherein a projecting portion supporting a bottom surface of the yoke is formed on a surface of the mounting portion opposite to the bottom surface of the yoke.

3. The speaker unit according to claim 2, wherein the projecting portion is formed into an annular shape.

4. The speaker unit according to claim 2, wherein the plural projecting portions are formed in a circumferential direction of the mounting portion with predetermined spaces with each other.

5. The speaker unit according to claim 2,
wherein the magnetic circuit and the resin frame have openings at center portions thereof, and
wherein the magnetic circuit is fixed to the resin frame by a fastening member inserted into the openings.

6. A speaker device comprising:
the speaker unit according to claim 5; and
another speaker unit disposed coaxially with respect to the speaker unit by the fastening member.
